(19) United States
(12) Patent Application Publication
(10) Pub. No.: US 2012/0247832 A1
(43) Pub. Date: Oct. 4, 2012

(54) SYSTEM, METHOD AND APPARATUS FOR PROTECTING DOWNHOLE COMPONENTS FROM SHOCK AND VIBRATION

(75) Inventors: David S. Cramer, Okotoks (CA); David D. Devlin, Calgary (CA)

(73) Assignee: PHOENIX TECHNOLOGY SERVICES LP, Calgary (CA)

(21) Appl. No.: 13/076,510

(22) Filed: Mar. 31, 2011

(51) Int. Cl. E21B 41/00; F16F 7/00; F16F 13/00; E21B 47/00

(52) U.S. Cl. 175/40; 166/113; 166/65.1; 267/140.13; 175/56

(57) ABSTRACT

A downhole tool assembly has a component that is sensitive to shock and vibration. A reciprocating element is coupled to the component. The reciprocating element has an axial internal passage and an outer surface. A housing has an internal axial bore for receiving the reciprocating element for axial reciprocal motion therein. A retainer is mounted to the housing and seals the housing between the component and the reciprocating element. A first spring is located between the housing and the reciprocating element. A second spring is located between the reciprocating element and the retainer. A first reciprocating seal is located between the reciprocating element and the housing. A second reciprocating seal is located between the connector and the retainer. A fluid is contained by the reciprocating seals inside the housing. The reciprocating element permits a limited amount of fluid to flow between sides thereof.

### BACKGROUND OF THE INVENTION

1. Field of the Disclosure

The present invention relates in general to protecting downhole components from shock and vibration while drilling a well and, in particular, to a system, method and apparatus for protecting measurement while drilling (MWD) equipment from shock and vibration.

2. Description of the Related Art

Some oil and gas exploration and production companies use vibrating devices known as agitators to increase penetration rates while drilling wells. Agitators typically operate or reciprocate between about 12 and 26 hertz during drilling operations, and constantly vibrate at these frequencies. Accordingly, agitators provide additional shock and vibration throughout the drill string that improve drilling performance. However, these devices can cause damage to or the failure of the downhole components, such as the sensitive electronic components of MWD systems. Moreover, the equipment may be subjected to high temperatures in the range of 150° C. as well as g-force vibration and shock on the order of 100 g in amplitude.

Shock absorbing systems, such as snubbers, have been added to drill strings to better protect MWD systems. Some conventional snubbers are silicone or elastomer-based and have a relatively high natural frequency. These systems also tend to be over-damped and are so stiff that they have virtually no shock absorbing capability. Thus, improvements in snubbers for MWD equipment would be desirable.

### SUMMARY

Embodiments of a system, method and apparatus for protecting MWD equipment from shock and vibration are disclosed. In some embodiments, a downhole tool assembly comprises a component that is sensitive to shock and vibration; a reciprocating element coupled to the component, the reciprocating element having an axial internal passage and an outer surface; a housing having an internal axial bore for receiving the reciprocating element for axial reciprocal motion therein; a retainer mounted to the housing and sealing the housing between the component and the reciprocating element; a first spring located between the housing and the reciprocating element; a second spring located between the reciprocating element and the retainer; a first reciprocating seal located between the reciprocating element and the housing; a second reciprocating seal located between the connector and the retainer; a fluid contained by the reciprocating seals inside the housing; and the reciprocating element permits a limited amount of fluid to flow between sides thereof.

In other embodiments, a snubber shock assembly may comprise a housing having an axis and an axial passage; a bushing mounted in the axial passage of the housing, the bushing having a piston bore and an outer surface; a piston located in the piston bore of the bushing and having a boss received in the axial passage for axial reciprocal motion therein, and the boss permits fluid flow between axial sides of the boss; a first spring located between the boss of the piston and the bushing; a tube mounted to the piston and extending axially therefrom opposite the bushing for axial motion with the piston, and a tool mount that is adapted to be mounted to a tool component; a retainer mounted to the housing and having a retainer bore that receives the tube such that the tube is axially movable relative to the retainer; and a second spring located between the boss of the piston and the retainer.

In still other embodiments, an agitator drilling assembly may comprise a drill string; an agitator mounted in the drill string to vibrate and increase penetration rate while drilling; a MWD tool having a plurality of components mounted in the drill string; and snubber shock assemblies mounted in the drill string between at least some of the components of the MWD tool such that the snubber shock assemblies are mounted inside the MWD tool, and said at least some of the components float axially and are protected from shock and vibration.

Embodiments of methods of protecting a component from shock and vibration while drilling a well may comprise drilling a well with a drill string; operating the component during the drilling of the well; vibrating the component at a vibration frequency; and protecting the component from shock and vibration at a natural frequency that is less than the vibration frequency.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1 is a sectional side view of one embodiment of a snubber assembly;

FIG. 2 is a sectional end view of an embodiment of the snubber assembly of FIG. 1, taken along the line 2-2 of FIG. 1;

FIG. 3 is a schematic sectional view of a well having an embodiment of a drill string with MWD and snubber assemblies; and

FIG. 4 is an enlarged, partially exploded sectional view of a portion of the drill string of FIG. 3.

The use of the same reference symbols in different drawings indicates similar or identical items.

### DETAILED DESCRIPTION

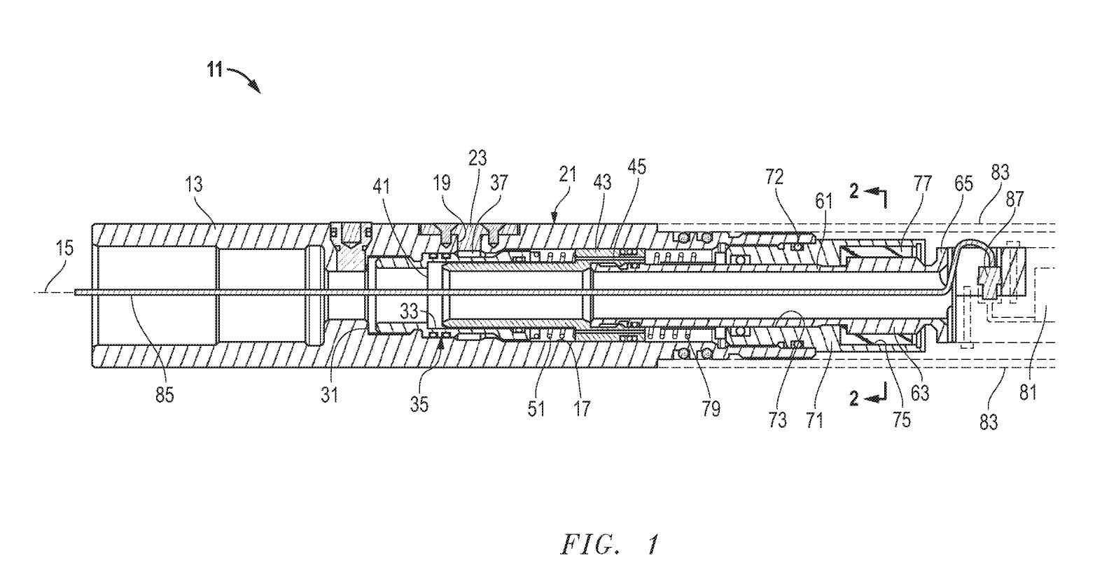

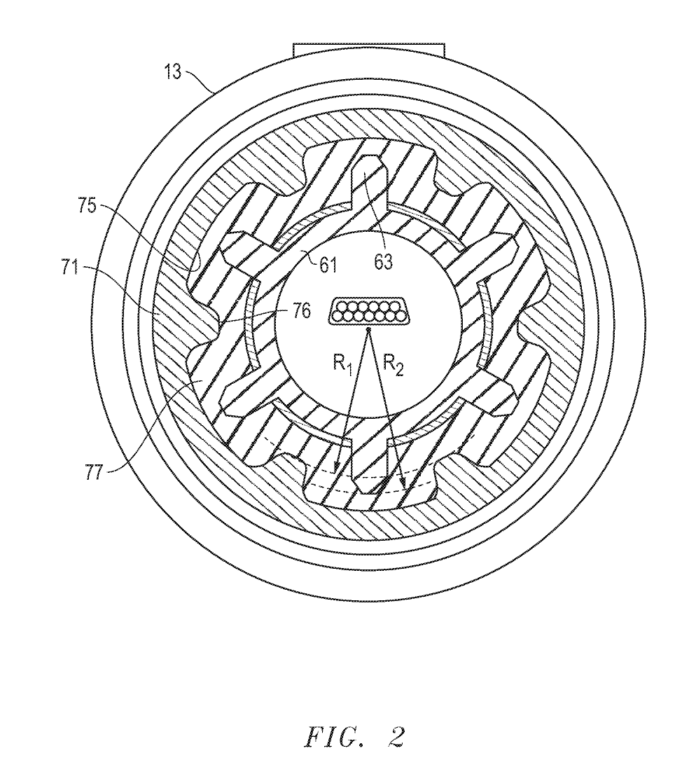

Embodiments of a system, method and apparatus for protecting MWD equipment from shock and vibration are disclosed. For example, FIGS. 1 and 2 illustrate one embodiment of snubber shock assembly 11. Snubber shock assembly 11 may comprise a housing 13 having an axis 15, an axial passage 17, a fill port 19 extending from an exterior 21 of the housing 13 to the axial passage 17, and an fluid fill cover 23 mounted and sealed to the fill port 19 as shown.

A bushing or seal housing 31 may be mounted in and coaxial with the axial passage 17 of the housing 13. The seal housing has a piston bore 33 and an outer surface 35, and at least a portion 37 of the outer surface 35 may be recessed adjacent the fill port 19.

The snubber shock assembly 11 may further comprise a piston 41 that is hollow and extends into the piston bore 33 of the seal housing 31 for coaxial reciprocal motion therein. In some embodiments, the piston has an axial travel range of approximately one inch (e.g., +/−one-half inch). The piston 41 has a boss 43 that is axially external to the seal housing 31 and is received in the axial passage 17 of the housing 13. The boss 43 may have means for allowing a limited amount of fluid to bypass the piston. For example, at least one damping jet 45 (e.g., two shown) may extend through boss 43 in an axial direction for permitting fluid to flow therethrough to either axial side of the boss 43 in the axial passage 17. The damping jets 45 in the piston 41 allow fluid to pass through and control the damping ratio in the system. Alternatively, a small radial separation between the boss and the axial passage may be used to permit fluid flow around the boss. A first spring 51 surrounds a portion of the piston 41 and is located between the boss 43 of the piston and the seal housing 31.

In some embodiments, a piston tube or tube 61 that is hollow is threaded to the piston 41 and extends axially therefrom opposite the seal housing 31 for axial motion with the piston 41. The tube 61 may comprise a spline on one end (right side of FIG. 1) with a plurality of tube ribs 63 (FIG. 2) extending in an axial direction and protruding radially therefrom. A tool mount 65 is axially external to a retainer 71. The tool mount 65 is adapted to be mounted to a component 81 of a measurement while drilling (MWD) tool, such as a power supply (e.g., battery), sensor, and/or transmitter. The component 81 typically is located inside a pressure barrel 83, which is threaded and sealed to the housing 13.

The piston retainer or retainer 71 is mounted in (e.g., threaded to) and coaxial with the axial passage 17 of the housing 13. The retainer 71 has a retainer bore 73 that receives the tube 61 and the tube 61 is axially movable relative to the retainer 71. The seal housing 31 and the retainer may both be threaded and sealed to the housing 13, which has fluid (e.g., oil) in the axial passage 17.

As best shown in FIG. 2, a keyway 75 may be located in the retainer bore 73 and is complementary to and receives the tube ribs 63 of the spline of the tube 61. A compliant bushing 77 (e.g., an elastomeric material such as rubber) is mounted between the keyway 75 and tube ribs 63 of the spline to dampen torsional shock therebetween. The keyway 75 may comprise a plurality of keyway ribs 76 that extend longitudinally in the axial direction and protrude radially inward from the keyway 75. In some embodiments, the keyway ribs 76 have radially innermost ends located at a first radial distance R₁ from the axis 15. The tube ribs 63 have radially outermost ends located at a second radial distance R₂ from the axis 15, which is greater than the first radial distance R₁. This design physically limits the torsional range of motion of tube ribs 63, tube 61 and piston 41.

A second spring 79 may be provided to surround a portion of the tube 61 and located between the boss of the piston and the retainer. For example, the first and second springs 51, 79 may comprise wave springs, such as Redux™ wave springs, and may be mounted in parallel.

A cable 85 extends through the housing 13, seal housing 31, piston 41, tube 61 and the retainer 71. The cable may have a connector 87 (e.g., an MDM connector) that is mounted to the tube 61 external of the housing 13 and the retainer 71 at the tool mount 65. The connector 87 is adapted to be connected to the MWD component 81 as shown in FIG. 1.

The component 81 (e.g., battery, electronics, etc.) may be connected to the snubber laterally as opposed to axially so that the stresses caused by axial vibrations in the connecting screws are seen as shear rather than tension. Some conventional designs bolt the tools together axially, but the lateral arrangement is more stable as well as being easier to service. In operation, several snubbers may be used in a single downhole assembly to insulate several components as desired.

In operation, the axial passage 17 may be filled with fluid (e.g., oil) through the fill port 19. Prior to filling, the snubber shock assembly 11 and fluid may be immersed in an oil bath and heated to a temperature of about 175° C. Thereafter, the fluid fill cover 23 may be mounted and sealed to the fill port 19 while the assembly is still submerged. Appropriate seals are provided between these various components.

The shock absorber has no accumulator inside so an allowance for thermal expansion of the oil is desirable. Most wells are drilled with temperatures exceeding 80° C., so allowance for thermal expansion helps the shock absorber avoid hydraulic lock up as the internal pressure increases. Incorporating the oil filling process by filling up the shock absorber while it is completely submerged in oil and heated the prior to being plugged allows the oil to expand. Once the desired temperature is reached the assembly is plugged, sealed and allowed to cool, leaving a small air gap inside.

To protect MWD components from shock and vibration, the snubber shock assembly 11 may be slightly under damped and have a natural frequency of less than about 10 Hz. For example, the natural frequency may be about 3 to 9 Hz. Since the vibration frequency range of agitators is known, a mechanical spring used by the shock absorber may be selected whose natural frequency was outside of that range. These springs help ensure that the snubber does not operate at the same resonant frequency as the agitators, which can cause significant damage to the MWD electronics and batteries while drilling.

As an example, the mass of a suspended battery or electronics device is about 8 pounds or 3.6 kg. To achieve a natural frequency of less than 10 Hz and conform to the small volume required of this shock absorber, wave springs were selected. Placing two wave springs in parallel with a 3.6 kg weight yields a natural frequency of about 8.77 Hz. The springs are small enough to fit inside an inner diameter of about 1.2 inches, but also allow an inner diameter of about 0.625 inches, which is large enough to permit a connector and a wiring assembly to fit therethrough. This design also permits proper sealing around the springs to keep the oil chamber separated from the wiring channel while maintaining structural integrity. In some embodiments, the overall length of snubber shock assembly 11 is approximately 5 inches, with an outer diameter of about 1.5 inches.

While an under-damped system demonstrates an increase in vibration as the input frequency is close to the natural frequency, at higher input frequencies the measured oscillation is less than what would be seen in an over-damped system. In the present example, the natural frequency was kept very low so that virtually any input would be above the natural frequency. This design has the benefit of reducing vibration on the order of 50% compared to conventional snubbers.

Another obstacle to overcome in snubber design is friction. Shock absorbers that use viscous damping are beneficial because they absorb even small impacts quite well. There is almost always friction damping involved in these devices, but the problem with the friction component is that its effects are greater at low impact amplitudes and low masses. In general, a device frictionally “sticks” at its current position until a significant impact breaks the static friction to initiate movement. The seals need to be tight enough to prevent leaking but low enough to avoid excessive friction.

For example, one embodiment of a seal 72 for sealing between the housing 13 and retainer 71 is energized by a canted coil spring. Canted coil springs provide a constant rate as they are compressed. This design maintains enough pressure to seal and maintain that same sealing pressure over a large range of tolerances or wear diameters without having to overcompensate and use too much pressure (and thus friction) when the tolerances are tight. In some embodiments, the seal is a plastic material that is bonded to the metal canted spring, which means that the seal is very structurally sound. In addition, it may be seated in a recess in one of the components to avoid deformation during installation.

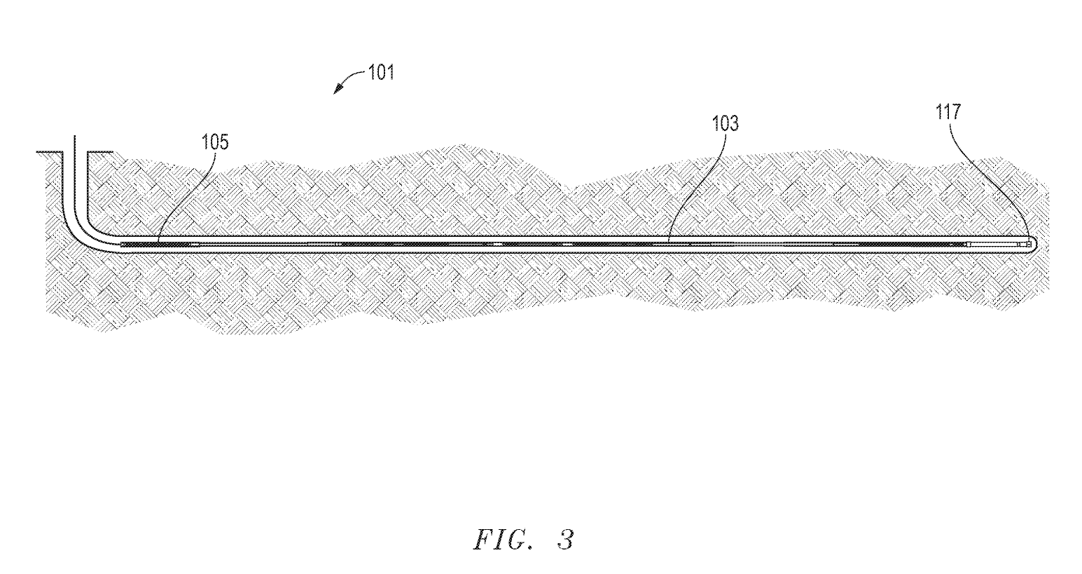

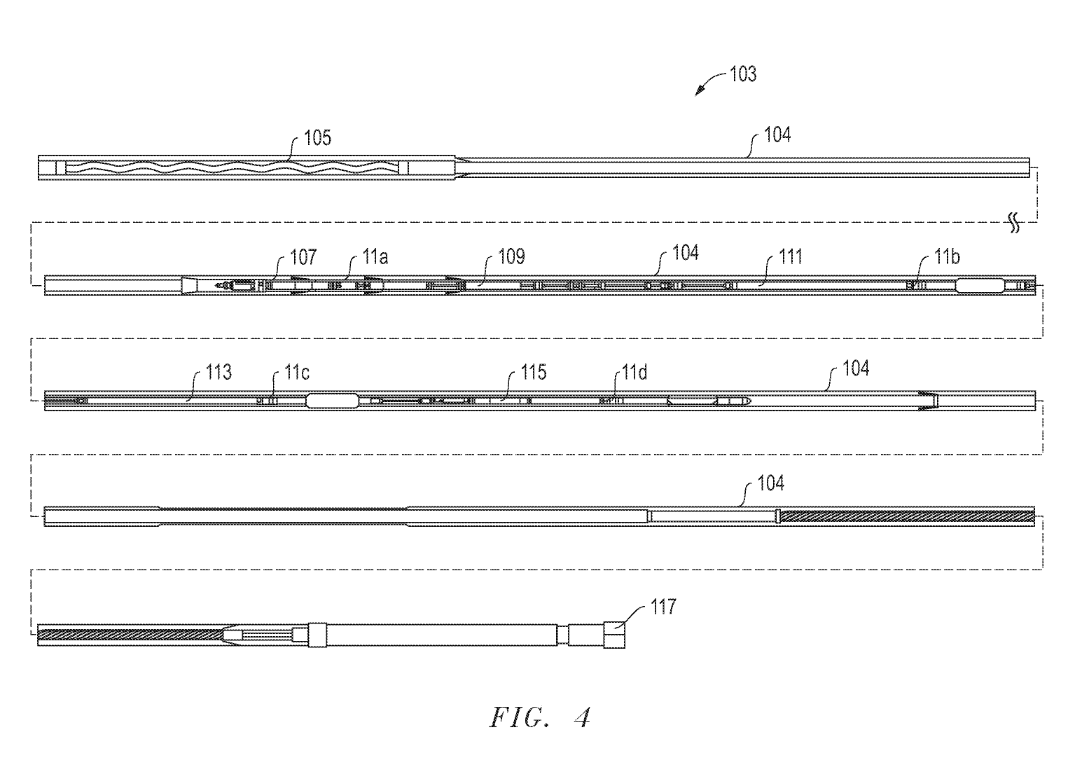

FIGS. 3 and 4 depict one embodiment of a system used in protecting components from shock and vibration while drilling a well. FIG. 3 depicts a well 101 having an embodiment of a drill string 103 with MWD and snubber shock assemblies 11. FIG. 4 is an enlarged, partially exploded sectional view of a portion of the drill string 103 of FIG. 3. Drill string 103 may include a plurality of connected joints of drill collars 104 that house an agitator 105 coupled to an MWD tool 107 having electronics 109 that are protected by a snubber shock assembly 11a. Another snubber shock assembly 11b is connected to and protects a battery stave 111 further downhole. A second battery stave 113 is supported by snubber shock assembly 11c, and a sensor 115 is protected by snubber shock assembly 11d. Other power supplies (e.g., alternators, etc.) and components (e.g., transmitters, etc.) also be employed and protected by this system. In some embodiments, one snubber shock assembly is secured to one axial end of a component to be protected, and a shock cord is secured to the other axial end of the protected component such that it “floats” axially within the drill string. A drill bit 117 is located on the lower end of the drill string 103.

Embodiments of the snubber shock assembly provide a significant reduction in the shock experienced by the components that they protect. For example, some initial measurements of damping capability yielded a 92% reduction in the shock felt from small (e.g., 0.75-inch) transient inputs. By comparison, conventional snubbers such as silicone dampers achieved no greater than a 30% reduction in shock.

In some embodiments, a downhole tool assembly comprises a component that is sensitive to shock and vibration; a reciprocating element coupled to the component, the reciprocating element having an axial internal passage and an outer surface; a housing having an internal axial bore for receiving the reciprocating element for axial reciprocal motion therein; a retainer mounted to the housing and sealing the housing between the component and the reciprocating element; a first spring located between the housing and the reciprocating element; a second spring located between the reciprocating element and the retainer; a first reciprocating seal located between the reciprocating element and the housing; a second reciprocating seal located between the connector and the retainer; a fluid contained by the reciprocating seals inside the housing; and the reciprocating element permits a limited amount of fluid to flow between sides thereof.

The downhole tool assembly may further comprise a cable with a connector extending through the housing, reciprocating element and retainer, and the connector is connected to the component. The component may comprise at least one component of a measurement while drilling (MWD) tool. The reciprocating element may be under damped and has a natural frequency of less than about 10 Hz. The natural frequency may be about 3 to 9 Hz.

In other embodiments, a downhole tool assembly for measurement while drilling (MWD) a well comprises an MWD component; a reciprocating element coupled to the MWD component, the reciprocating element has an axial passage and an outer surface comprising a small diameter and a large diameter; a connector that couples the MWD component to the reciprocating element, the connector having an outer surface with a diameter substantially equal to the small diameter of the reciprocating element; a housing having an axial bore for receiving the reciprocating element for axial reciprocal motion therein; a retainer mounted to the housing and having an axial bore for receiving the connector outer surface; a first spring on the small diameter of the reciprocating element and located between a shoulder of the axial bore of the housing and a face of the reciprocating element; a second spring on the connector and located between another face of the reciprocating element and a face of the retainer; a first reciprocating seal between the small diameter of the reciprocating element and the axial bore of the housing; a second reciprocating seal between the connector and the retainer; a fluid contained by the reciprocating seals inside of the housing; and the reciprocating element allows a limited amount of fluid to flow between axial sides of the large diameter in the axial bore of the housing.

The reciprocating element may comprise damping jets extending therethrough to permit fluid flow between axial sides of the reciprocating element. The housing may further comprise a fill port extending from an exterior of the housing to the axial bore, and a fluid fill cover mounted and sealed to the fill port. The axial bore may be filled with fluid through the fill port, and the downhole tool assembly and fluid are at a temperature of about 175° C. when the fluid fill cover is mounted and sealed to the fill port. The downhole tool assembly may further comprise a cable with an electrical connector extending through the housing, reciprocating element, connector and retainer, the electrical connector is mounted to the connector external of the housing and the retainer, and the electrical connector is connected to the MWD component. The MWD component may comprise at least one of a power supply, sensor, and transmitter.

The downhole tool assembly may be under damped and has a natural frequency of less than about 10 Hz. The natural frequency may be about 3 to 9 Hz. The first and second springs may be wave springs that are mounted in parallel. The connector may have a spline with plurality of ribs extending in an axial direction and protruding radially therefrom, the retainer has a keyway that is complementary to and receives the spline, and a compliant bushing is mounted between the keyway and the spline to dampen torsional shock. The keyway may comprise a plurality of keyway ribs extending in an axial direction and protruding radially inward from the keyway. The keyway ribs may have innermost ends located at a first radial distance from the axis, and the ribs have outermost ends located at a second radial distance from the axis that is greater than the first radial distance.

In still other embodiments, a snubber shock assembly may comprise a housing having an axis and an axial passage; a bushing mounted in the axial passage of the housing, the bushing having a piston bore and an outer surface; a piston located in the piston bore of the bushing and having a boss received in the axial passage for axial reciprocal motion therein, and the boss permits fluid flow between axial sides of the boss; a first spring located between the boss of the piston and the bushing; a tube mounted to the piston and extending axially therefrom opposite the bushing for axial motion with the piston, and a tool mount that is adapted to be mounted to a tool component; a retainer mounted to the housing and having a retainer bore that receives the tube such that the tube is axially movable relative to the retainer; and a second spring located between the boss of the piston and the retainer. The snubber shock assembly may comprise other elements and features as described herein.

In another embodiment, the snubber shock assembly comprises a housing having an axis, an axial passage, a fill port extending from an exterior of the housing to the axial passage, and an fluid fill cover mounted and sealed to the fill port; a seal housing mounted in and coaxial with the axial passage of the housing, the seal housing having a piston bore and an outer surface, and at least a portion of the outer surface is recessed adjacent the fill port; a piston that is hollow extending into the piston bore of the seal housing for axial reciprocal motion therein, the piston having a boss external to the seal housing and received in the axial passage, the boss having a damping jet extending therethrough in an axial direction for permitting fluid to flow therethrough to either axial side of the boss; a first spring surrounding a portion of the piston and located between the boss of the piston and the seal housing; a tube that is hollow threaded to the piston and extending axially therefrom opposite the seal housing for axial motion with the piston, the tube having a spline with a plurality of tube ribs extending in an axial direction and protruding radially therefrom, and a tool mount that is adapted to be mounted to a component of a measurement while drilling (MWD) tool; a retainer mounted in and coaxial with the axial passage of the housing, the retainer having a retainer bore that receives the tube and the tube is axially movable relative to the retainer, a keyway that is complementary to and receives the spline of the tube, and a compliant bushing mounted between the keyway and spline to dampen torsional shock; and a second spring surrounding a portion of the piston tube and located between the boss of the piston and the retainer. The snubber shock assembly may comprise other elements and features as described herein.

In still other embodiments, an agitator drilling assembly may comprise a drill string; an agitator mounted in the drill string to vibrate and increase penetration rate while drilling; a MWD tool having a plurality of components mounted in the drill string; and snubber shock assemblies mounted in the drill string between at least some of the components of the MWD tool such that the snubber shock assemblies are mounted inside the MWD tool, and said at least some of the components float axially and are protected from shock and vibration. Each of the snubber shock assemblies may further comprise elements and features described elsewhere herein.

Embodiments of methods of protecting a component from shock and vibration while drilling a well may comprise drilling a well with a drill string; operating the component during the drilling of the well; vibrating the component at a vibration frequency; and protecting the component from shock and vibration at a natural frequency that is less than the vibration frequency. The natural frequency may be about 3 to 9 Hz. The vibration frequency may be at least 12 Hz, or about 12 to 26 Hz. The component is protected from axial and torsional shock and vibration.

In other embodiments, a method of protecting MWD components from shock and vibration while drilling a well may comprise drilling a well with a drill string; performing measurement while drilling (MWD) operations during the drilling of the well; agitating the drill string at an agitation frequency; and protecting at least a component of the MWD operations from shock and vibration at a natural frequency that is less than the agitation frequency. These methods may comprise other elements and features as described elsewhere herein.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A downhole tool assembly, comprising:
a component that is sensitive to shock and vibration;
a reciprocating element coupled to the component, the reciprocating element having an axial internal passage and an outer surface;
a housing having an internal axial bore for receiving the reciprocating element for axial reciprocal motion therein;
a retainer mounted to the housing and sealing the housing between the component and the reciprocating element;
a first spring located between the housing and the reciprocating element;
a second spring located between the reciprocating element and the retainer;
a first reciprocating seal located between the reciprocating element and the housing;
a second reciprocating seal located between the connector and the retainer;
a fluid contained by the reciprocating seals inside the housing; and
the reciprocating element permits a limited amount of fluid to flow between sides thereof.

2. A downhole tool assembly according to claim 1, further comprising a cable with a connector extending through the housing, reciprocating element and retainer, and the connector is connected to the component.

3. A downhole tool assembly according to claim 2, wherein the component comprises at least one component of a measurement while drilling (MWD) tool.

4. A downhole tool assembly according to claim 1, wherein the reciprocating element is under damped and has a natural frequency of less than about 10 Hz.

5. A downhole tool assembly according to claim 4, wherein the natural frequency is about 3 to 9 Hz.

6. A downhole tool assembly for measurement while drilling (MWD) a well, comprising:
an MWD component;
a reciprocating element coupled to the MWD component, the reciprocating element has an axial passage and an outer surface comprising a small diameter and a large diameter;
a connector that couples the MWD component to the reciprocating element, the connector having an outer surface with a diameter substantially equal to the small diameter of the reciprocating element;
a housing having an axial bore for receiving the reciprocating element for axial reciprocal motion therein;
a retainer mounted to the housing and having an axial bore for receiving the connector outer surface;
a first spring on the small diameter of the reciprocating element and located between a shoulder of the axial bore of the housing and a face of the reciprocating element;
a second spring on the connector and located between another face of the reciprocating element and a face of the retainer;
a first reciprocating seal between the small diameter of the reciprocating element and the axial bore of the housing;
a second reciprocating seal between the connector and the retainer;
a fluid contained by the reciprocating seals inside of the housing; and
the reciprocating element allows a limited amount of fluid to flow between axial sides of the large diameter in the axial bore of the housing.

7. A downhole tool assembly according to claim 6, wherein the reciprocating element comprises damping jets extending therethrough to permit fluid flow between axial sides of the reciprocating element.

8. A downhole tool assembly according to claim 6, wherein the housing further comprises a fill port extending from an exterior of the housing to the axial bore, and a fluid fill cover mounted and sealed to the fill port.

9. A downhole tool assembly according to claim 8, wherein the axial bore is filled with fluid through the fill port, and the downhole tool assembly and fluid are at a temperature of about 175° C. when the fluid fill cover is mounted and sealed to the fill port.

10. A downhole tool assembly according to claim 6, further comprising a cable with an electrical connector extending through the housing, reciprocating element, connector and retainer, the electrical connector is mounted to the connector external of the housing and the retainer, and the electrical connector is connected to the MWD component.

11. A downhole tool assembly according to claim 6, wherein the MWD component comprises at least one of a power supply, sensor, and transmitter.

12. A downhole tool assembly according to claim 6, wherein the downhole tool assembly is under damped and has a natural frequency of less than about 10 Hz.

13. A downhole tool assembly according to claim 12, wherein the natural frequency is about 3 to 9 Hz.

14. A downhole tool assembly according to claim 6, wherein the first and second springs are wave springs and are mounted in parallel.

15. A downhole tool assembly according to claim 6, wherein the connector has a spline with plurality of ribs extending in an axial direction and protruding radially therefrom, the retainer has a keyway that is complementary to and receives the spline, and a compliant bushing is mounted between the keyway and the spline to dampen torsional shock.

16. A downhole tool assembly according to claim 15, wherein the keyway comprises a plurality of keyway ribs extending in an axial direction and protruding radially inward from the keyway.

17. A downhole tool assembly according to claim 16, wherein the keyway ribs have innermost ends located at a first radial distance from the axis, and the ribs have outermost ends located at a second radial distance from the axis that is greater than the first radial distance.

18. A snubber shock assembly, comprising:
a housing having an axis and an axial passage;
a bushing mounted in the axial passage of the housing, the bushing having a piston bore and an outer surface;
a piston located in the piston bore of the bushing and having a boss received in the axial passage for axial reciprocal motion therein, and the boss permits fluid flow between axial sides of the boss;
a first spring located between the boss of the piston and the bushing;
a tube mounted to the piston and extending axially therefrom opposite the bushing for axial motion with the piston, and a tool mount that is adapted to be mounted to a tool component;
a retainer mounted to the housing and having a retainer bore that receives the tube such that the tube is axially movable relative to the retainer; and
a second spring located between the boss of the piston and the retainer.

19. A snubber shock assembly according to claim 18, wherein the boss comprises damping jets extending therethrough in an axial direction to permit fluid flow therethrough between the axial sides of the boss.

20. A snubber shock assembly according to claim 18, wherein the housing further comprises a fill port extending from an exterior of the housing to the axial passage, and an fluid fill cover mounted and sealed to the fill port, the bushing has an outer surface, and at least a portion of the outer surface is recessed adjacent the fill port.

21. A snubber shock assembly according to claim 20, wherein the axial passage is filled with fluid through the fill port, and the snubber shock assembly and fluid are at a temperature of about 175° C. when the fluid fill cover is mounted and sealed to the fill port.

22. A snubber shock assembly according to claim 18, wherein the bushing and the retainer are each threaded to the housing, there are seals between the components, and further comprising fluid in the axial passage.

23. A snubber shock assembly according to claim 18, further comprising a cable with a connector extending through the housing, bushing, piston, tube and retainer, the connector is mounted to the tube external of the housing and the retainer, and the connector is adapted to be connected to the tool component.

24. A snubber shock assembly according to claim 23, wherein the tool component comprises at least one of a measurement while drilling (MWD) power supply, sensor, and transmitter.

25. A snubber shock assembly according to claim 18, wherein the snubber shock assembly is under damped and has a natural frequency of less than about 10 Hz.

26. A snubber shock assembly according to claim 25, wherein the natural frequency is about 3 to 9 Hz.

27. A snubber shock assembly according to claim 18, wherein the first and second springs are wave springs and are mounted in parallel.

28. A snubber shock assembly according to claim 18, wherein the tube has a spline with plurality of tube ribs extending in an axial direction and protruding radially therefrom, the retainer has a keyway that is complementary to and receives the spline of the tube, and a compliant bushing is mounted between the keyway and the spline to dampen torsional shock.

29. A snubber shock assembly according to claim 28, wherein the keyway comprises a plurality of keyway ribs extending in an axial direction and protruding radially inward from the keyway.

30. A snubber shock assembly according to claim 29, the keyway ribs have innermost ends located at a first radial distance from the axis, and the tube ribs have outermost ends located at a second radial distance from the axis that is greater than the first radial distance.

31. A snubber shock assembly according to claim 28, wherein the compliant bushing is formed from an elastomeric material.

32. A snubber shock assembly, comprising:
a housing having an axis, an axial passage, a fill port extending from an exterior of the housing to the axial passage, and an fluid fill cover mounted and sealed to the fill port;
a seal housing mounted in and coaxial with the axial passage of the housing, the seal housing having a piston bore and an outer surface, and at least a portion of the outer surface is recessed adjacent the fill port;
a piston that is hollow extending into the piston bore of the seal housing for axial reciprocal motion therein, the piston having a boss external to the seal housing and received in the axial passage, the boss having a damping jet extending therethrough in an axial direction for permitting fluid to flow therethrough to either axial side of the boss;
a first spring surrounding a portion of the piston and located between the boss of the piston and the seal housing;
a tube that is hollow threaded to the piston and extending axially therefrom opposite the seal housing for axial motion with the piston, the tube having a spline with a plurality of tube ribs extending in an axial direction and protruding radially therefrom, and a tool mount that is adapted to be mounted to a component of a measurement while drilling (MWD) tool;
a retainer mounted in and coaxial with the axial passage of the housing, the retainer having a retainer bore that receives the tube and the tube is axially movable relative to the retainer, a keyway that is complementary to and receives the spline of the tube, and a compliant bushing mounted between the keyway and spline to dampen torsional shock; and
a second spring surrounding a portion of the piston tube and located between the boss of the piston and the retainer.

33. A snubber shock assembly according to claim 32, further comprising a cable extending through the housing, seal housing, piston, tube and retainer, and having with an MDM connector that is mounted to the tube external of the housing and the retainer, and the MDM connector is adapted to be connected to an MWD component, which comprises at least one of a power supply, sensor, and transmitter.

34. A snubber shock assembly according to claim 32, wherein the axial passage is filled with fluid through the fill port, the snubber shock assembly and fluid are at a temperature of about 175° C. when the fluid fill cover is mounted and sealed to the fill port, and there are seals between the components.

35. A snubber shock assembly according to claim 32, wherein the snubber shock assembly is under damped and has a natural frequency of less than about 10 Hz.

36. A snubber shock assembly according to claim 35, wherein the natural frequency is about 3 to 9 Hz.

37. A snubber shock assembly according to claim 32, wherein the first and second springs are wave springs and are mounted in parallel.

38. A snubber shock assembly according to claim 32, wherein the keyway comprises a plurality of keyway ribs extending in an axial direction and protruding radially inward from the keyway, the keyway ribs have innermost ends located at a first radial distance from the axis, and the tube ribs have outermost ends located at a second radial distance from the axis that is greater than the first radial distance.

39. A snubber shock assembly according to claim 32, wherein the compliant bushing is formed from an elastomeric material, and the seal housing and the retainer are each threaded to the housing, and further comprising fluid in the axial passage.

40. An agitator drilling assembly, comprising:
a drill string;
an agitator mounted in the drill string to vibrate and increase penetration rate while drilling;
a MWD tool having a plurality of components mounted in the drill string;
snubber shock assemblies mounted in the drill string between at least some of the components of the MWD tool such that the snubber shock assemblies are mounted inside the MWD tool, and said at least some of the components float axially and are protected from shock and vibration, each snubber shock assembly further comprising:
a reciprocating element coupled to one of the components, the reciprocating element having an axial internal passage and an outer surface;
a housing having an internal axial bore for receiving the reciprocating element for axial reciprocal motion therein;
a retainer mounted to the housing and sealing the housing between said at least one of the components and the reciprocating element;
a first spring located between the housing and the reciprocating element;
a second spring located between the reciprocating element and the retainer;
a first reciprocating seal located between the reciprocating element and the housing;
a second reciprocating seal located between the connector and the retainer;
a fluid contained by the reciprocating seals inside the housing; and
the reciprocating element permits a limited amount of fluid to flow between sides thereof.

41. An agitator drilling assembly according to claim 40, wherein the agitator has an operational frequency of at least 12 Hz.

42. An agitator drilling assembly according to claim 41, wherein the operational frequency is about 12 to 26 Hz.

43. An agitator drilling assembly according to claim 40, wherein each of the snubber shock assemblies has a natural frequency of no more than 10 Hz.

44. An agitator drilling assembly according to claim 40, wherein the natural frequency is about 3 to 9 Hz.

45. An agitator drilling assembly according to claim 40, wherein said at least one component is protected from axial and torsional shock and vibration.

46. An agitator drilling assembly according to claim 40, wherein said at least one component comprises electronics or a power supply.

47. A method of protecting a component from shock and vibration while drilling a well, comprising:
drilling a well with a drill string;
operating the component during the drilling of the well;
vibrating the component at a vibration frequency; and
protecting the component from shock and vibration at a natural frequency that is less than the vibration frequency.

48. A method according to claim 47, wherein the natural frequency is about 3 to 9 Hz.

49. A method according to claim 47, wherein the vibration frequency is at least 12 Hz.

50. A method according to claim 49, wherein the vibration frequency is about 12 to 26 Hz.

51. A method according to claim 47, wherein the component is protected from axial and torsional shock and vibration.

52. A method of protecting MWD components from shock and vibration while drilling a well, comprising:
drilling a well with a drill string;
performing measurement while drilling (MWD) operations during the drilling of the well;
agitating the drill string at an agitation frequency; and
protecting at least a component of the MWD operations from shock and vibration at a natural frequency that is less than the agitation frequency.

53. A method according to claim 52, wherein the agitation frequency is at least 12 Hz.

54. A method according to claim 52, wherein the agitation frequency is about 12 to 26 Hz.

55. A method according to claim 52, wherein the natural frequency is no more than 10 Hz.

56. A method according to claim 52, wherein the natural frequency is about 3 to 9 Hz.

57. A method according to claim 52, wherein the at least one component of the MWD operations is protected from axial and torsional shock and vibration.
